(19) United States
(12) Patent Application Publication
(10) Pub. No.: US 2009/0199929 A1
(43) Pub. Date: Aug. 13, 2009

(54) Working Device

(76) Inventors: Ola Svensson, Halmstad (SE); Thomas Jonsson, Falkenberg (SE)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 12/308,852

(22) PCT Filed: Jul. 3, 2007
(86) PCT No.: PCT/SE2007/000659

§ 371 Date: Dec. 24, 2008

(30) Foreign Application Priority Data
Jul. 4, 2006 (SE) 0601455-9

(51) Int. Cl. B27M 3/00

(52) U.S. Cl. 144/345

(57) ABSTRACT

A device for working of a length of timber or lengths of timber and similar materials frame sections for roof wherein a plurality of conveyors are disposed for a displacement of the lengths of timber substantially in the longitudinal direction of the conveyors and transversely of the longitudinal direction of lengths of timber that at least the conveyors located most proximal the ends of the lengths of timber is/are switchable transversely of the feeding direction and thereby in the longitudinal direction of the lengths of timber in a direction to and from the ends of the lengths of timber and that a number of working units with a number of tool holders each for its or their working tool are displaceable in relation to the lengths of timber to a working position.

The present invention relates to a device for working according to the preamble to appended claim 1.

In particular within the industry for the production of timber houses, e.g. prefabricated timber houses, it is desirable to be able to produce wall sections, roof sections, roof trusses or the like in as rational and rapid a manner as possible without jeopardising reliability and accuracy. It is further of major importance that the parts included be easy to handle on their assembly to form the desired elements, e.g. a wall section or a roof truss. It should naturally also be simple and rational to handle raw materials and feed them into a machine for their processing or working. It is further desirable to be able, with one and the same working device or machine, to straight saw, mitre saw, mill and plane etc., one or more lengths of timber possibly at the same time, in order to achieve as high a degree of rationalisation as possible.

The task forming the basis of the present invention is to satisfy the above-outlined needs and wishes.

This task is solved according to the present invention in that the device intimated by way of introduction has been given the characterising features as set forth in appended claim 1.

The present invention realises, above all, an extremely rational working which makes possible several such working phases as straight sawing, mitre sawing, milling, planing etc., of one or more lengths of timber separately or simultaneously. In the same working device, it is possible to carry out such difficult working phases as the mitre sawing of eaves from lengths of timber intended to be included in roof trusses as rafter sections. As a result of the present invention, it is also possible to numerically control the working device. It is further possible as a result of the present invention to carry out working phases of different types on different types of lengths of timber without any manually adjustments whatever. What is required is substantially only so-called software instructions.

The present invention will be described in greater detail hereinbelow with reference to the accompanying Drawings.

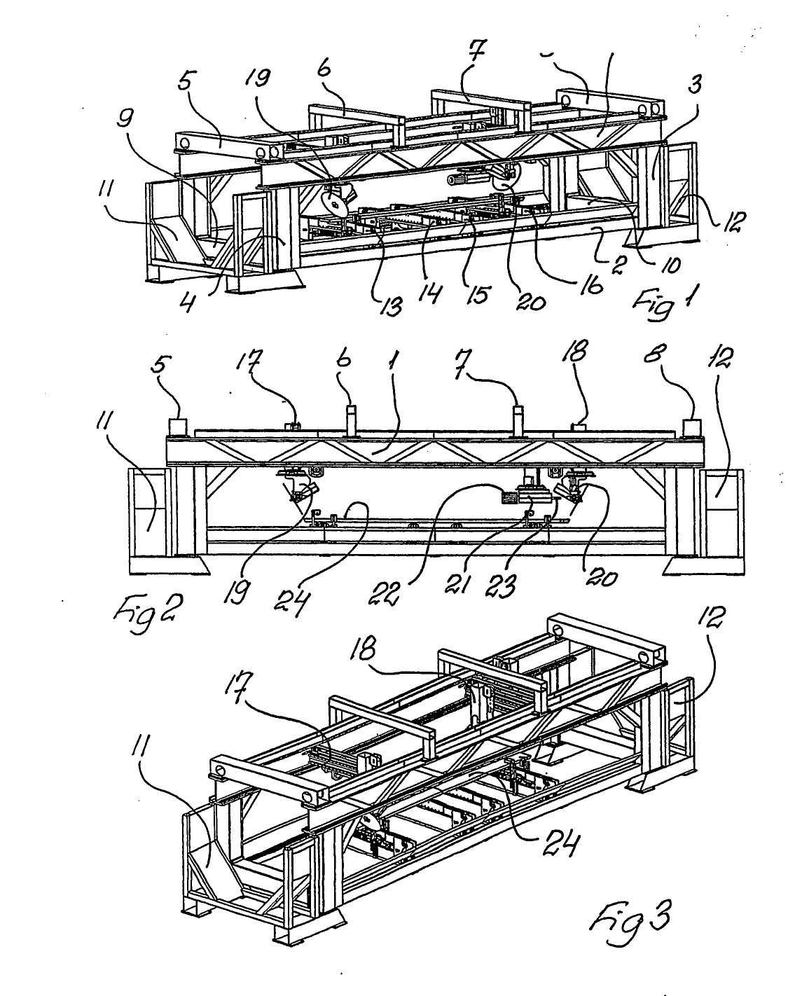

FIG. 1 is a schematic view seen from the infeed side of one embodiment of a device according to the present invention.

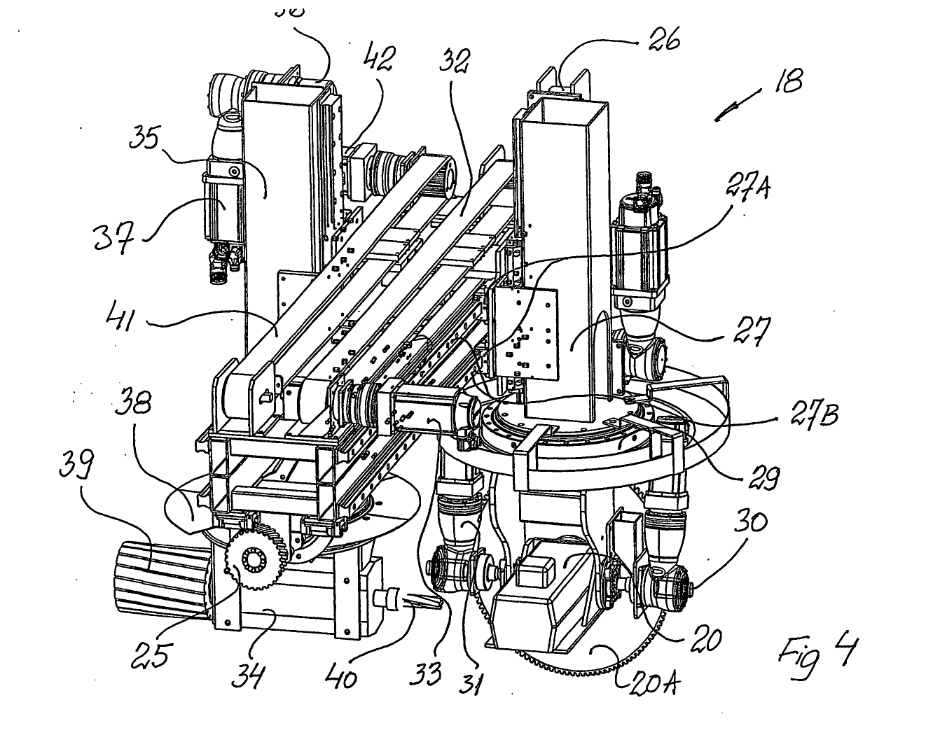

FIG. 2 is a view straight from the infeed side of the device illustrated in FIG. 1.

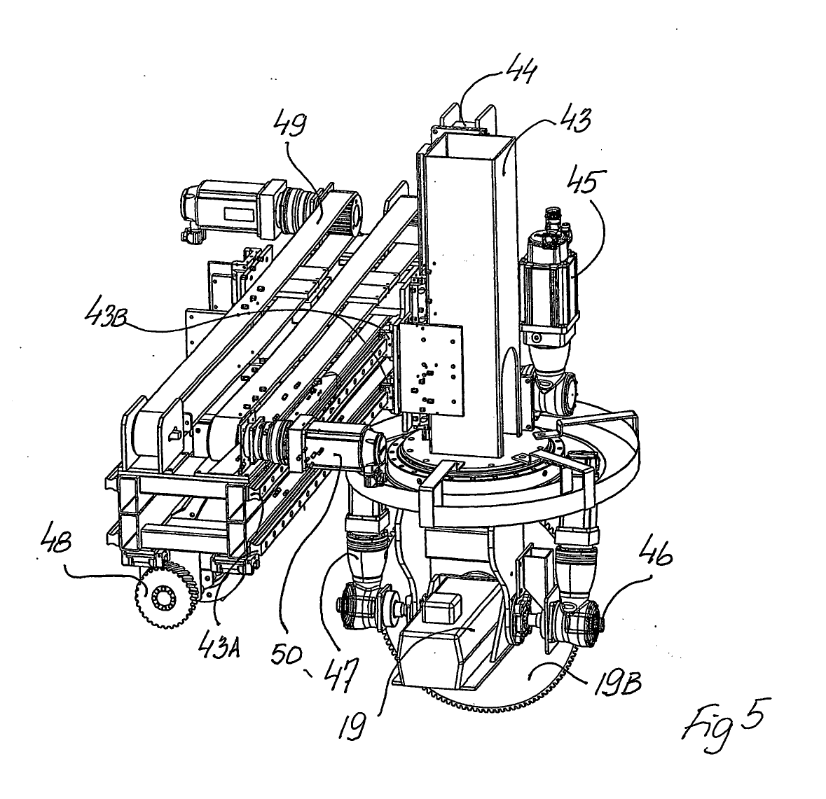

FIG. 3 is a view obliquely from above of the embodiment shown in FIG. 1 of a device according to the present invention.

FIG. 4 is a schematic perspective view of a processing unit or working unit according to one embodiment of a device according to the present invention.

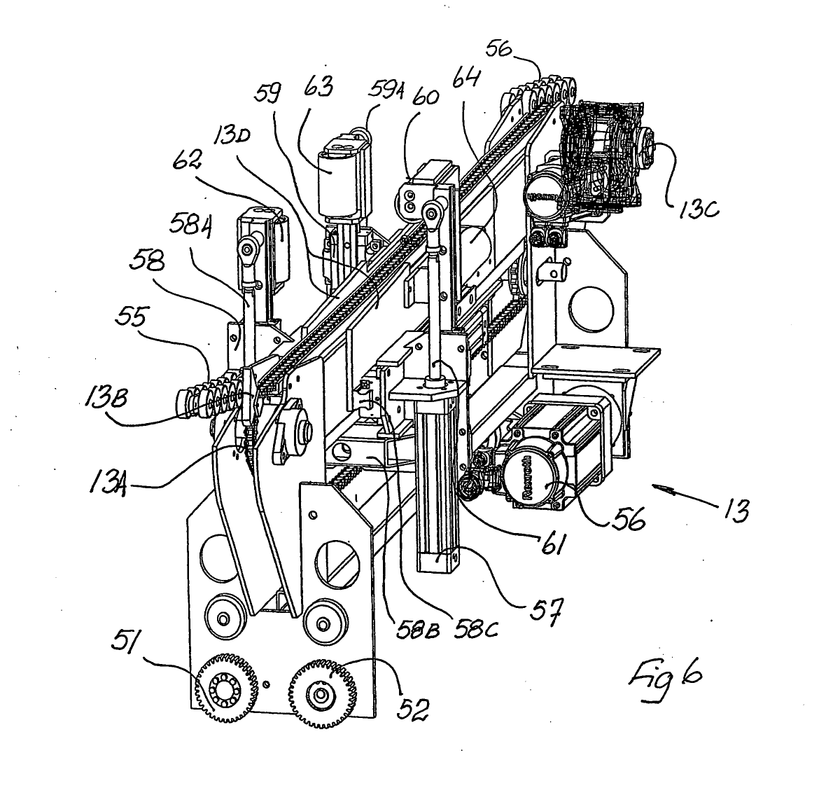

FIG. 5 is a perspective view of a further working unit according to one embodiment of the device according to the present invention.

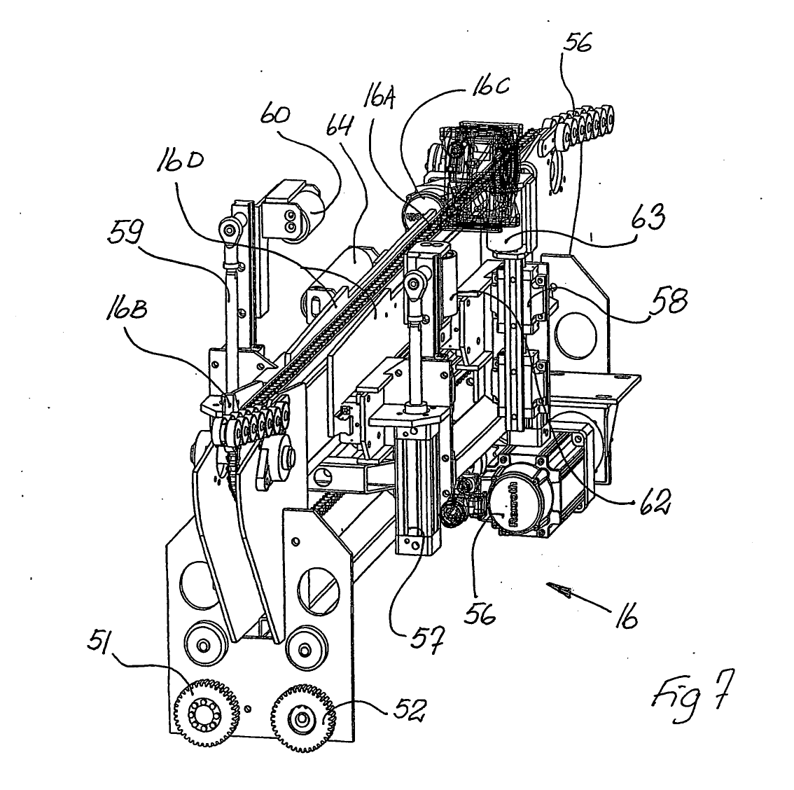

FIG. 6 is a perspective view of a conveyor according to one embodiment of the device according to the present invention.

FIG. 7 is a perspective view of another conveyor according to one embodiment of the device according to the present invention.

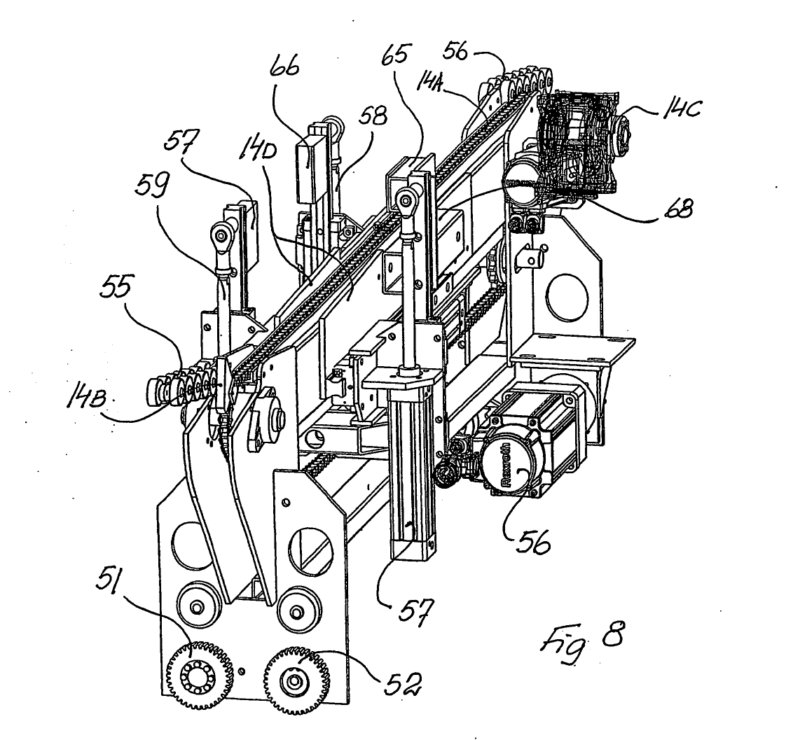

FIG. 8 is a perspective view of a conveyor according to one embodiment of the device according to the present invention.

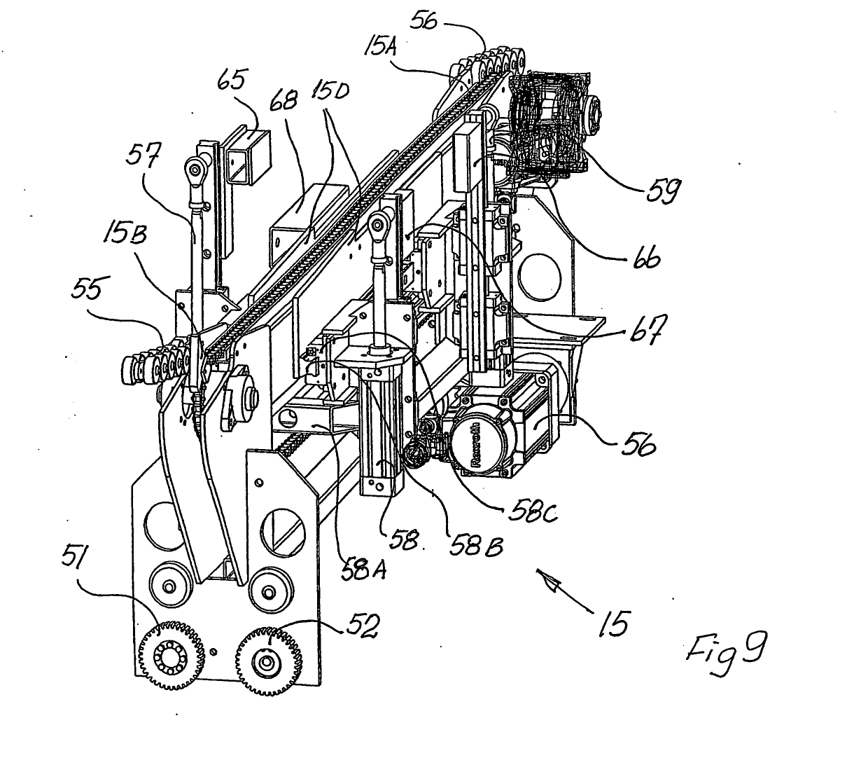

FIG. 9 is a schematic perspective view of yet a further conveyor according to one embodiment of the device according to the present invention.

According to FIGS. 1-3, the illustrated embodiment of a device according to the present invention is provided with a machine frame which includes one of a pair of mutually parallel rectangular beam arrangements, which comprise a lower beam 1, an upper beam 2 and two end beams 3 and 4. The beam arrangements are interconnected to one another by means of upper cross beams 5, 6, 7 and 8, and lower cross beams 9 and 10. The beam arrangements rest in two end walls 11 and 12 which are also constructed from a number of beams.

Between the beams 2 extend four conveyors 13, 13, 15 and 16 which are each provided with a chain 13A, 14A, 15A and 16A, with one or more carriers 13B in FIG. 6 and 14B in FIG. 8 for moving the timber length 24 or timber lengths to and past loaders or positioners in low position flush with or beneath the chains 13A-16A which, for purposes of driving, are each connected to their motor 13C-16C. The conveyors 13-16 are switchable in the longitudinal direction of the upper and the lower beams 1 and 2. The side illustrated in FIG. 1 is the infeed side, which implies that the length or lengths of timber that are to be worked are placed on the conveyors 13-16 either manually or by means of an infeed device which, however, does not constitute a germane part of the subject matter of the present invention. On the one or both sides of the chains 13A-16A, there are disposed rails 13D-16D on which the length or lengths of timber 24 rest during the displacement by means of the carriers 13B-16B on the chains 13A-16A.

Between the upper beams 1, there are disposed two carriages 17 and 18. Like the conveyors 13-16, the carriages 17 and 18 are displaceable on gear racks extending along the beams 1. The carriage 17 supports a cutting saw unit 19 with cutting saw blade 19A, while the carriage 18 supports a cutting saw unit 20 with cutting saw blade 20A and an additional tool holder 21. The tool holder 21 supports a cutter 22 and a shank-end mill 23. The cutting saw units 19 and 20 are vertically adjustable and rotary for adjustment of the saw blade 19A, 20A in the vertical position or in any angle in relation thereto. The tool holder 21 is rotary for placing the cutter 22 or the shank-end mill 23 in the working position. Further, the cutting saw units 19 and 20 are adjustable in the vertical direction. This also applies to the tool holder 21. Moreover, the cutting saw units 19 and 20 as well as the tool holder 21 are displaceable on the carriages 17 and 18 in the longitudinal direction of the carriages 17 and 18, thus between the beams 1 and 2 for placing each respective working unit in the desired position for executing the desired working process.

FIGS. 1-3 show a length of timber 24 which is held in the working position by means of so-called loaders or positioners on the conveyors 13 and 14. The loaders or positioners will be described in greater detail with reference to FIGS. 6-9. In FIGS. 1-3, the length of timber 24 is held in the working position by means of the loaders or positioners on the conveyors 13-16, the conveyors 13 and 16 having so-called moving loaders or positioners. The term moving loaders or positioners is taken to signify that, after gripping the length of timber 24, they permit displacement of the conveyors 13 and 16 provided therewith in relation to the length of timber 24 during gripping thereof and are, therefore, provided with rollers. The conveyors 13 and 16 are thus displaceable along the length of timber 24 in order to make possible long saw cuts with unchanged support during the working operation by means of the cutting saw units 19, 20. This displacement is of major importance in the carrying out of long saw cuts with the aid of the cutting saw units 19 and 20 which, in such instances, are also displaced in the longitudinal direction of the saw cut with the aid of the carriages 17, 18 and the units 19 and 20.

The intermediate conveyors 14 and 15 are provided with so-called fixed loaders for holding the length of timber 24 during displacement of the outer conveyors 13 and 16 along the length of timber 24 and are, therefore, provided with fixed jaws. The intermediate conveyors 14 and 15 are fixed during the working process, while the outer conveyors 13 and 16 are displaceable by means of gear wheels and gear racks in that the loaders or positioners are provided with rollers. By such means, displacement is permitted of the working support which is afforded by means of the conveyors.

The four conveyors 13, 14, 15 and 16 further permit cutting of a length of timber 24 such as straight cutting at the ends, but also resawing transversely or at an angle. In addition, several lengths of timber, e.g. two in number, may be positioned above one another, whereby it is possible to obtain four lengths of ready-sawn and ready processed timber at the same time. The dimensions of the lengths of timber 24 are exemplified to such great lengths as up to approx. 6.6 metres and their width may amount to approx. 250 mm and thickness to approx. 100 mm and, as was mentioned above, two lengths of timber of a thickness of 50 mm can be laid on one another for ready processing of four lengths simultaneously.

In FIG. 4, the carriage 18 is shown in greater detail, the carriage being movable on gear racks along the beams 1 and 2 by means of a gear wheel 25 at each end. In addition, the carriage 18 supports a cutting saw unit 20 which is vertically adjustable by means of a toothed belt 26 driven by a suitable motor 28. The cutting saw unit 20 is mounted at the end of a carrier 27 which is switchable in the vertical direction by means of, the toothed belt 26 which is driven by the motor 28. The cutting saw unit 27 is mounted on a disk 29 to be rotary or pivotal in the horizontal plane, while the cutting saw unit 2 is angular-adjustable about a shaft 30 by means of a motor 31. The cutting saw unit 20 is angular-adjustable between in principle a vertical position and approx. 30°, e.g. 28°, by means of the motor 31. The carrier unit 27 supports a slide 27A in order to be movable on a rail 27B along the carriage 18 with the aid of the toothed belt 32 which is driven by means of a motor 33. In the illustrated embodiment, the carriage 18 has two rails 27A and the carrier unit 27 has two slides 27B for each rail.

The carriage 18 further supports a tool carrier 34 which is mounted on a carrier unit 35 which is vertically switchable by means of a toothed belt 36 via a motor 37. The tool carrier 34 is further rotary by means of a disk 38 by means of a suitable motor (not shown) which may possibly be integrated in the disk 38. At the one end of the tool carrier 34, there is disposed a cutter 39 and at the opposite end a shank-end mill 40. The carrier 35 is displaceable along the carriage 18 on rails 35A as well as slides (not shown on the Drawings, but substantially of the same type as the slides 27A), with the aid of a toothed belt 41 which is drivable by means of a motor 42. In that the carriage 18 is switchable along the beams 1 and 2, and in that the tool carriers 27 and 35 are switchable along the carriage, and also vertically, the different working tools may be placed at any desired position whatever for processing a length of timber 24.

The carriage 19 is shown in greater detail in FIG. 5 and supports a cutting saw unit 19 which is angular-adjustable at the end of a carrier unit 43 which is largely identical with the carrier unit 27 and is vertically switchable by means of a toothed belt 44 driven by means of a motor 45. The cutting saw unit 19 is angular-adjustable on a shaft 46 by means of a motor 47. Like the carriage 18, the carriage 19 is displaceable along the beams 1 and 2 by means of gear wheels 48 at each end, each on a gear rack. The carrier unit 43 is displaceable along the carriage 19 on rails 43A and slides 43B with the aid of a toothed belt 49 and a motor 50. The gear wheels 25 and 48 are each coupled to a motor or motors for displacement of the carriages 18 and 19, respectively, along the gear racks along the beams 1 and 2. By means of the two cutting saw units 19 and 20, double sawing will thus be made possible in the device according to the present invention, which makes for an extremely rational sawing of lengths of timber.

FIGS. 6-9 show the four conveyors 13, 14, 15 and 16 in greater detail. The conveyor 13 is shown in greater detail in FIG. 6, while the conveyor 16 is shown in greater detail in FIG. 7. The conveyor 14 is shown in greater detail in FIG. 8 and the conveyor 15 is shown in greater detail in FIG. 9. All of the conveyors 13-15 are movable on gear racks extending along the beams 2, with the aid of gear wheels 51 and 52 at the ends of the conveyors for placing the conveyors 13-16 in the desired position along the beams 1 and 2. Each conveyor has an infeed roller arm 55 and a discharge roller arm 56 as well as the previously mentioned chains 13A-16A. The gear wheels 51 and 52 at the one end serve the function of drive and/or support wheels, while the gear wheels 51 and 52 at the other end also serve the function of support and drive wheels. The drive wheels 51 may be interconnected by means of a longitudinal shaft. In such instance, it is appropriate that the one drive wheel is coupled to a motor 56 for the desired switching of the conveyors 13-16 along the beams 1 and 2. Each conveyor further displays a number of vertically switchable loaders or positioners 57, 58, 59.

The loader or positioner 57 of the conveyor 13 is movable in the longitudinal direction of the conveyor 13 and in the vertical direction by means of a piston and cylinder assembly 61. The loader or positioner 58 is switchable in the vertical direction by means of a piston and cylinder assembly 58A. The loaders or positioners 57 and 58 are mounted on a cross beam 58B, together with which the loaders or positioners 57 and 58 are switchable in the longitudinal direction of the conveyor with the aid of a piston and cylinder assembly (not shown) in order, after having been passed by a length of timber 24 and switching to the position illustrated in FIG. 6, to move the length of timber 24 into abutment against a loader or positioner 58 which is vertically switchable by means of a piston and cylinder assembly 59A of substantially the same type as the piston and cylinder assembly 58A and 61. The loaders 57, 58 and 59 are also each provided with a roller 60, 62 and 63. In the area of the loaders or positioners 57, 58, 59 of the conveyor 13, the rails 13D-16D are lowered to a level slightly above the chain 13A. In this region, the conveyor has a support roller 64 whose longitudinal axis is parallel with the longitudinal direction of the conveyor 13 and on which the length of timber 24 will be placed by means of the carrier 13B on the chain 13A. The support roller 64 and the rollers 60, 62 and 63 permit displacement of the conveyor 13 in the longitudinal direction of the length of timber 24 while sawing of a long cut in the length of timber 24. By such means, the support of the length of timber will be moved together with the cutting saw unit 19. This is particularly important on sawing of long cuts in the length of timber 24, for example cutting for eaves. The conveyor 16 in FIG. 7 is largely identical, whereby symmetry will be attained throughout the entire sawing device, since the conveyor 13 in FIG. 6 is located to the left in the device, while the conveyor 16 in FIG. 7 is located to the right in the device according to FIGS. 1-3, seen in that direction in which the length of timber 24 is fed into the device.

The conveyors 14 and 15 illustrated in FIGS. 8 and 9 have loaders or positioners 57, 58 and 59 which are vertically switchable by means of piston and cylinder assemblies. The loader or positioner 58 is interconnected to the loader or positioner 57 by means of a cross beam 58A for switching in the longitudinal direction of the conveyor on a rail 58B on each side of the conveyor and a slide 58C with the aid of a piston and cylinder assembly (not shown). The loaders or positioners 57, 58 and 59 of the conveyors 14 and 15 are so-called fixed loaders and the ends are each provided with a jaw 65, 55 and 67, which fixedly hold the length of timber 24 while it is being worked or processed and do not permit movement of the length of timber 24 or the conveyors 14 and 15. On these conveyors 14 and 15, the support rollers 64 on the conveyors 13 and 16 have been replaced by fixed supports 68.

The piston and cylinder assemblies included in the device according to the present invention may be pneumatic or hydraulic and the motors may be hydraulic and/or electric and be selected depending upon the function which is to be carried out both from the point of view of accuracy and from the point of view of speed. As was mentioned above, the device according to the present invention may be provided with NC control which may be extremely sophisticated so that, int. al., account is taken of the dimensions (length, width, thickness) of the lengths of timber that are available, for attaining as optimum and rational utilisation as possible.

Many modifications are naturally possible without departing from the inventive concept as this is defined in the appended Claims.

1. A device for working of a length of timber or lengths of timber for roof trusses of optional cross section, wherein a plurality of conveyors are disposed for displacement of the length(s) of timber substantially in a longitudinal direction of the conveyors and transversely of the longitudinal direction of the length(s) of timber, that at least the conveyor(s) located most proximal end(s) of the length(s) of timber is/are switchable transversely of a feeding direction and thereby in the longitudinal direction of the length(s) of timber in a direction to and from the end(s) of the length(s) of timber, and that a number of working units with a number of tool holders each for its or their working tool are displaceable in relation to the length(s) of timber to a working position.

2. The device as claimed in claim 1, wherein at least two conveyors include means for drawing in or aligning and positioning of the length of timber in the working position and for permitting displacement of the conveyor transversely of the feeding direction and thereby in the longitudinal direction of the timber during simultaneous positioning thereof during working in the working position, and at least two conveyors include means for drawing in or aligning and fixedly retaining the length of timber in the working position.

3. The device as claimed in claim 1, wherein the working assemblies are mounted each on a carriage which is displaceable both transversely and longitudinally or the length of lengths of timber to a working position for carrying out the desired working while the length(s) of timber is/are stationary on the conveyor.

4. The device as claimed in claim 2, wherein said means for drawing in or aligning and positioning the length of timber in the working position and for permitting displacement of the conveyor transversely of the feeding direction and thereby in the longitudinal direction of the length of timber during simultaneous positioning thereof during working in the working position include rollers which are disposed to permit displacement of the conveyor in the longitudinal direction of the length of timber during working, while the length of timber is positioned in the working position by both the rollers and said means for drawing in or aligning and fixedly retaining the length of timber in the working position are disposed to fixedly abut against the length of timber.

5. The device as claimed in claim 1, wherein the conveyors each include an infeed chain and a roller wheel package at the infeed end and a roller wheel package at a discharge end.

6. The device as claimed in claim 1, wherein at least one working assembly is provided with a saw unit with a cutting saw blade, and that the saw unit with the cutting saw blade is angular-adjustable and rotary.

7. The device as claimed in claim 1, wherein at least one working assembly is provided with both a saw unit with a cutting saw blade and an additional working unit with a shank-end mill and a cutter the saw unit with the cutting saw blade being angular-adjustable and rotary and the additional working unit with the shank-end mill and the cutter being rotary for positioning the shank-end mill or the cutter in the working position.

8. The device as claimed in claim 2, wherein the roller means and said means for fixed abutment are vertically switchable from a position for engagement with the length(s) of timber and a position beneath a path of movement of the length(s) of timber, in which passage of the length(s) of timber is permitted on the conveyors.

9. The device as claimed claim 2, wherein said roller means includes both vertical and horizontal rollers, while the conveyor therewith is provided with at least one support roller.

10. The device as claimed in claim 2, wherein the conveyors each include an infeed chain and a roller wheel package at the infeed end and a roller wheel package at a discharge end.

11. The device as claimed in claim 4, wherein the roller means and said means for fixed abutment are vertically switchable from a position for engagement with the length(s) of timber and a position beneath a path of movement of the length(s) of timber, in which passage of the length(s) of timber is permitted on the conveyors.

12. The device as claimed claim 4, wherein said roller means includes both vertical and horizontal rollers, while the conveyor therewith is provided with at least one support roller.

13. The device as claimed claim 8, wherein said roller means includes both vertical and horizontal rollers, while the conveyor therewith is provided with at least one support roller.
